(19) United States
(12) Patent Application Publication
(10) Pub. No.: US 2004/0245506 A1
(43) Pub. Date: Dec. 9, 2004

(54) Processing of high density magnesium boride wires and tapes by hot isostatic pressing

(76) Inventors: Yuntian T. Zhu, Los Alamos, NM (US); Adriana C. Serquis, Los Alamos, NM (US); Leonardo Civale, Los Alamos, NM (US); Xiaozhou Liao, Los Alamos, NM (US); Duncan L. Hammon, Los Alamos, NM (US); Fred M. Mueller, Los Alamos, NM (US); Dean E. Peterson, Los Alamos, NM (US); Yabei Gu, Pasadena, CA (US); Vitali F. Nesterenko, La Jolla, CA (US)

Correspondence Address: UNIVERSITY OF CALIFORNIA, LOS ALAMOS NATIONAL LABORATORY, P.O. BOX 1663, MS A187, LOS ALAMOS, NM, 87545, US

(21) Appl. No.: 10/456,639

(22) Filed: Jun. 5, 2003

(51) Int. Cl. H01B 1/00

(52) U.S. Cl. 252/500

(57) ABSTRACT

A process is disclosed of increasing the critical current density in a superconducting magnesium boride wire by heating a magnesium diboride precursor wire under isostatic pressure in an inert atmosphere at temperatures and for time sufficient to form a superconducting magnesium boride wire characterized as having a higher critical current density than a superconducting magnesium boride wire heated under the same temperature conditions in the absence of isostatic pressing.

### STATEMENT REGARDING FEDERAL RIGHTS

This invention was made with government support under Contract No. W-7405-ENG-36 awarded by the U.S. Department of Energy. The government has certain rights in the invention.

### FIELD OF THE INVENTION

The present invention relates to a process of increasing the critical current density in superconducting magnesium boride wires and tapes by the application of hot isostatic pressing.

### BACKGROUND OF THE INVENTION

Recently, magnesium boride (MgB₂) was found to exhibit superconducting properties below 39K. MgB₂ may be a cheaper alternate to conventional superconductors such as NbTi or Bi_{1.8}Pb_{0.4}Sr_{1.8}Ca_{2.0}Cu₃O₁₀₊ₓ (BSCCO) in the 20-30K and 0-12 Tesla (T) range for the fabrication of superconducting tapes or wires. MgB₂ superconducting tapes or wires may be used in a number of applications including transformers, magnets, magnetic resonance imagers (MRIs) and power transmission.

Superconducting tapes or wires of ceramic-like materials such as BSCCO are often fabricated by the powder-in-tube (PIT) method, which involves filling a metallic tube with a superconducting powder and drawing the filled tube into a superconducting wire. The wire can also be rolled to form a superconducting tape. All high temperature superconductors discovered so far have strong superconducting anisotropy, so that the superconducting grains/crystals need to be highly aligned/textured crystallographically in order to obtain high critical current density. For example, complex thermo-mechanical processing procedures have been developed to improve the texture of BSSCO superconducting tapes. These complex processing procedures significantly increase the processing cost.

MgB₂ has a weak anisotropy so that orienting the crystallographic grains of MgB₂ is not essential in obtaining high critical current densities. In addition, polycrystalline MgB₂ is free from weak link behavior at grain boundaries, making it easier to fabricate good superconducting wires and tapes using the traditional PIT methods. However, the PIT method cannot produce highly dense superconducting cores. The porosity significantly degrades the grain-to-grain connection and consequently reduces critical current density. Therefore, it is desirable to fabricate highly dense MgB₂ superconducting wires.

It is an object of the present invention to fabricate highly dense MgB₂ superconducting wires/tapes by hot isostatic processing (HIPing) of MgB₂ wires/tapes produced by the traditional PIT method.

### SUMMARY OF THE INVENTION

To achieve the foregoing and other objects, and in accordance with the purposes of the present invention, as embodied and broadly described herein, the present invention provides a process of increasing the critical current density in a superconducting magnesium boride wire including forming a magnesium diboride precursor wire by filling a metallic tube with magnesium diboride powder and reducing said filled tube to a predetermined size, and, heating said magnesium diboride precursor wire under isostatic pressure in an inert atmosphere at temperatures and for time sufficient to form a superconducting magnesium boride wire characterized as having a higher critical current density than a superconducting magnesium boride wire heated under the same temperature conditions in the absence of isostatic pressing.

### BRIEF DESCRIPTION OF THE DRAWINGS

FIG. 1a shows a comparison between the voltage (V)-current (I) relationships of a first MgB₂ wire before and after HIPing.

FIG. 1b shows a comparison between the voltage (V)-current (I) relationships of a second MgB₂ wire before and after HIPing.

FIG. 2 shows a plot of 4 πM/H vs. temperature at H=20 Oe for a MgB₂ wire.

### DETAILED DESCRIPTION

The present invention is concerned with preparation of magnesium boride tapes and wires with improved critical current densities.

In the present invention, a starting material of commercially available magnesium diboride (MgB₂) can be ball milled to form a uniform powder which can then be packed into a suitable metal tube such as a stainless steel tube. Other metals such as Fe, Nb and corrosion resistant alloys such as monel alloy may also be used. Generally, a small amount of excess magnesium powder is added as an extra source of magnesium in reaching the final MgB₂ product.

In the process of the present invention, the MgB₂ and magnesium starting materials are heated to temperatures between about 850° C. and about 925° C., preferably between about 875° C. and about 925° C. This heating is conducted under HIPing, i.e., hot isostatic pressing. Generally, the isostatic pressure can be from about 50 to 450 megapascals (MPa), preferably from about 150 to 250 MPa. After maintaining the starting materials at this temperature for a period of at least about 30 minutes, the pressure can be removed and the sample can be gradually cooled to room temperature at, e.g., a rate of about 5° C./minute.

The present invention is more particularly described in the following example which is intended as illustrative only, since numerous modifications and variations will be apparent to those skilled in the art.

### EXAMPLE 1

Commercial MgB₂ powder (from Alfa Aesar) was ball milled for two hours and packed into stainless steel tubes (inner and outer diameters were 3.1 and 6.4 millimeters (mm) for wire #1 and 4.6 and 6.4 mm for wire #2) in an argon atmosphere, adding about 5 percent by weight magnesium powder as an extra source of magnesium. The presence of excess magnesium is believed to aid in the formation of MgB₂ via a process of diffusion of magnesium vapor into the boron grains. The tubes were cold-drawn into round wires with a final external diameter of 1.4 mm, with an intermediate annealing (heated in vacuum at a fast rate of 35° C./minute, maintained at 900° C. for 30 minutes, and gas quenched with argon).

The resultant wires were cut into 10 centimeter (cm) long pieces, sealed at both ends using an electric arc welder. The wires were then HIPed at 900° C. under an isostatic pressure of 200 MPa for 30 minutes and then cooled at a rate of 5° C. per minute to room temperature. The pressure was removed before the cooling stage.

The dc transport critical current (I_{c}) was measured at 4 K, with the wires immersed in liquid helium. The sample pieces (10 cm length) had voltage contacts placed about 2 to 3 cm apart, in order to eliminate the initial ohmic behavior sometimes observed in I-V curves of shorter wires. I_{c} was defined using a 1 μV criterion. The I_{c} values were measured on the same wire before and after HIPing.

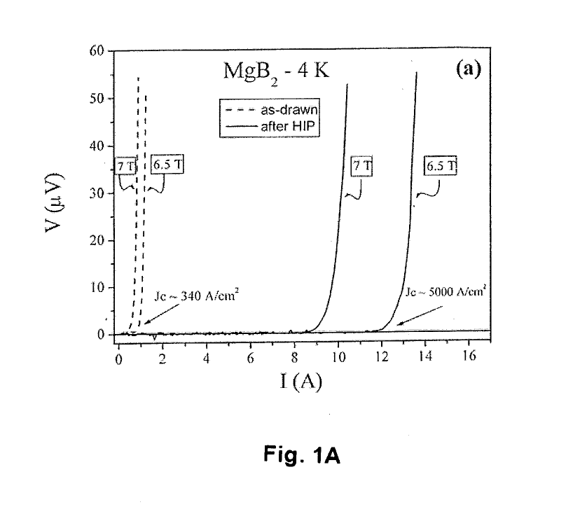

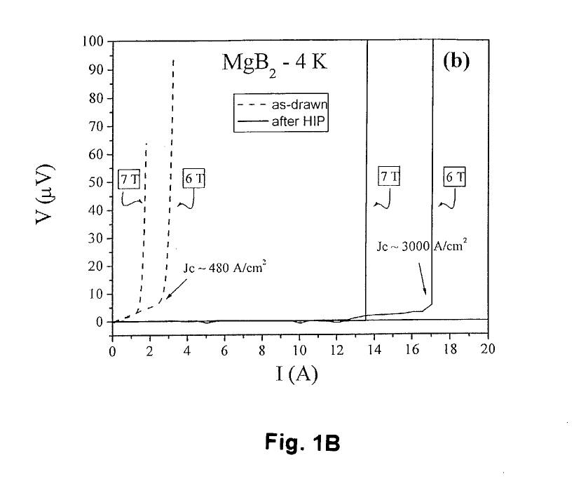

FIG. 1a compares the voltage (V)-current (I) relationship of MgB₂ wire #1 before and after HIPing. The superconductive core of wire #1 had a diameter of 0.57 mm. It can be seen that at a magnetic field of 6.5 Tesla (T), the critical current density, J_{c}=I_{c}/S (S is the cross section superconducting core), was improved from 340 amperes per square centimeter (A/cm²) to 5000 A/cm², i.e., J_{c} was improved by about 14 times.

FIG. 1b compares the voltage (V)-current (I) relationship of MgB₂ wire #2 before and after HIPing. The superconductive core of wire #2 had a diameter of 0.88 mm. It can be seen that at a magnetic field of 6.5 T, J_{c}, was improved from 480 A/cm² to 3000 A/cm², i.e., J_{c} was improved by about 5 times.

### EXAMPLE 2

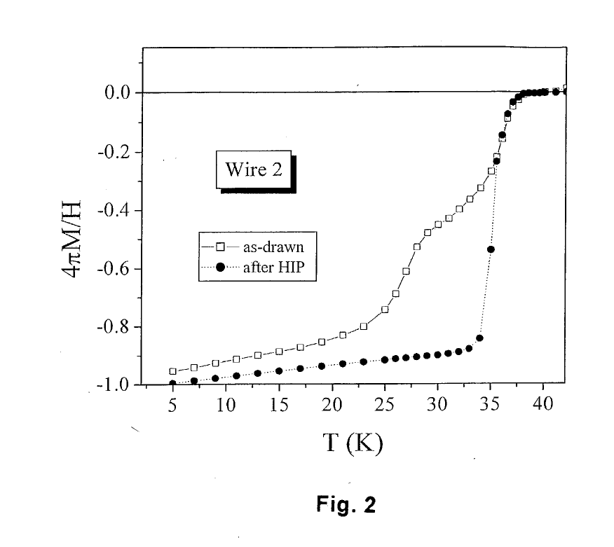

FIG. 2 shows 4 πM/H versus temperature at H=20 Oe for wire #2. The zero-field-cooling (ZFC) curve from the as-drawn wire #2 exhibits the two-steps typical of weak-link behavior. The weak link behavior was caused by porosity as well as cracks inside the wire. After HIPing, the two-step weak link behavior apparently disappeared, because HIPing had removed some porosity and healed some cracks in the wire. That is the explanation for why the J_{c} significantly increased after HIPing as shown in FIG. 1a and 1b.

From the results of this example, it is concluded that HIPing can significantly improve the critical current density in MgB₂ wires. The HIPed wires have a higher J_{c} than the annealed only wires, especially at high temperatures and magnetic fields, and higher irreversibility field (Hᵢᵣᵣ). The HIPed wires are promising for applications, with J_{c}>10⁶ A/cm² at 5 K and zero field and >10⁴ A/cm² at 1.5 T and 26.5 K, and Hᵢᵣᵣ˜17 T at 4 K. This is the highest irreversibility field for powder in tube (PIT) MgB₂. While not wishing to be bound by the present explanation, it is believed that the improvement is attributed to a high density of structural defects (induced by high temperature viscoplastic flow of magnesium diboride during HIPing), which are the likely source of vortex pinning. These defects, observed by transmission electron microscopy, include small angle twisting, tilting, and bending boundaries, resulting in the formation of sub-grains within MgB₂ crystallites.

Although the present invention has been described with reference to specific details, it is not intended that such details should be regarded as limitations upon the scope of the invention, except as and to the extent that they are included in the accompanying claims.

What is claimed is:

1. A process of increasing the critical current density in a superconducting magnesium boride wire comprising:
forming a magnesium diboride precursor wire by filling a metallic tube with magnesium diboride powder and reducing said filled tube to a predetermined size; and,
heating said magnesium diboride precursor wire under isostatic pressure in an inert atmosphere at temperatures and for time sufficient to form a superconducting magnesium boride wire characterized as having a higher critical current density than a superconducting magnesium boride wire heated under the same temperature conditions in the absence of isostatic pressing.

2. The process of claim 1 wherein said heating is at temperatures of from about 850° C. to about 950° C.

3. The process of claim 1 wherein said inert atmosphere is argon.

4. The process of claim 1 wherein said isostatic pressure is from about 150 to 250 MPa.

5. The process of claim 1 wherein a minor excess of magnesium powder in admixed with the magnesium diboride powder.

6. The process of claim 1 wherein said metal tube is of a metal selected from the group consisting of stainless steel, and iron, niobium and monel.
